(19) United States
(12) Patent Application Publication
(10) Pub. No.: US 2021/0289147 A1
(43) Pub. Date: Sep. 16, 2021

(54) IMAGES WITH VIRTUAL REALITY BACKGROUNDS

(71) Applicant: Intelligent Inventions Limited, Tsim Sha Tsui East, Kowloon (HK)

(72) Inventors: Pak Kit LAM, Kowloon (HK); Peter Han Joo CHONG, Kowloon (HK)

(21) Appl. No.: 16/477,166

(22) PCT Filed: Jan. 11, 2018
(86) PCT No.: PCT/IB2018/000071

§ 371 Date: Jul. 10, 2019

Related U.S. Application Data
(60) Provisional application No. 62/445,173, filed on Jan. 11, 2017.

(51) Int. Cl. H04N 5/272; G06T 3/40; G06T 11/00; H04N 5/232; G06T 3/60; G06T 3/20

(52) U.S. Cl. CPC H04N 5/272; G06T 3/40; G06T 11/00; G06F 3/0346; G06T 3/60; G06T 3/20; H04N 5/23293

(57) ABSTRACT

An electronic device having a display, memory, and an image sensor captures image data from the image sensor. The device receives a selection of a background image from a user of the electronic device. The background image 100is not based on image data from the image sensor. The device displays a view on the display or view-fmder. The view is based on the captured image data and the selected background image. The device receives first user input at the electronic device. The displayed view is updated by modifying the background image in accordance with the first user input while maintaining the display of the captured image data. The device stores the view as image data in the memory.

### CROSS-REFERENCE TO RELATED APPLICATIONS

This application claims priority to U.S. Provisional Patent Application Ser. No. 62/445,173, “Images with Virtual Reality Backgrounds,” filed Jan. 11, 2017, the content of which is hereby incorporated by reference for all purposes.

### FIELD

The present disclosure relates taking photos and, more specifically, to taking photos with alternative backgrounds.

### BACKGROUND

Inside a physical studio, images and videos are sometimes captured in a way that allows the images and video to be placed in front of an alternative background. For example, photographers can choose different physical background, such as some “background photo,” before capturing the image or video. However, the cost of preparing these physical backgrounds is high in terms of space needed and the time to prepare and maintain, and the results are often not realistic. Green screens are another alternative but have their own disadvantages.

### SUMMARY

In some embodiments of the invention, mobile apps can allow the photographer to select any background (e.g., a virtual reality (VR) background of image or video) for an image or a video subject (e.g., a model or any object being photographed or recorded). As a result, the subject will appear to be in a background, which can be static if it is a still image or dynamic if it is a video image, that is totally different from the real background that he/she/it is in front of. An example of this is that a subject, such as a person, can appear to be standing in front of the Eiffel Tower in Paris, France, while he/she/it is actually inside a studio, inside their home, outside, or anywhere else.

In some embodiments of the invention, a photographer can very conveniently select any preferred background from a device's storage or even an online database. Moreover, the photographer can adjust the size of the background to ensure it is proportional with where the subject is located (e.g., where a model is standing), and/or add proper shadowing in real-time to ensure the best result.

In some embodiments, when the background is VR based, the photographer has a realistic view of the background, and therefore can arrange the subject to the best spot and/or perform certain actions (e.g., a model pointing to the Eiffel Tower) in the most realistic manner The photographer can even take advantage of the 3-dimensional and 360-degree nature of VR technology, and take a picture from above or below the model. For example, the photographer can take a picture from a second floor, while the model stands on the ground, but the picture can be seen as taken from higher level of a mountain for the model standing at a lower-level of the mountain.

### BRIEF DESCRIPTION OF THE FIGURES

The present application can be best understood by reference to the figures described below taken in conjunction with the accompanying drawing figures, in which like parts may be referred to by like numerals.

FIGS. 1A-1B depict an exemplary electronic device that implements some embodiments of the present technology.

FIG. 2 depicts an exemplary user interface present in some embodiments of the present technology.

FIGS. 3A-3C depict interactions with a device for positioning a VR background on the display of the device.

FIGS. 4A-4C depict interactions with a device for position a VR background with respect to another image on the display of the device.

FIG. 5 is a block diagram of an electronic device that can implement some embodiments of the present technology.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the present technology. Thus, the disclosed technology is not intended to be limited to the examples described herein and shown, but is to be accorded the scope consistent with the claims.

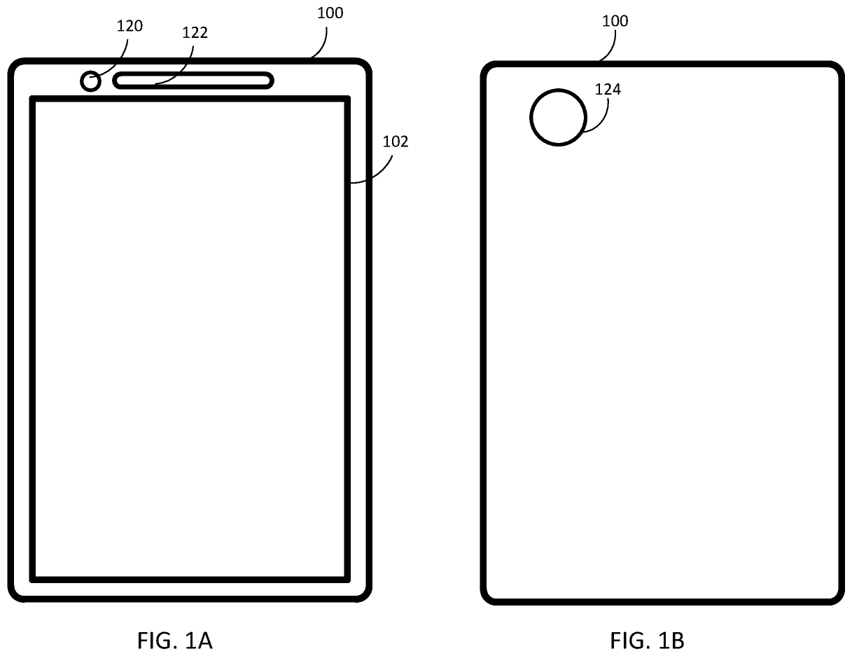

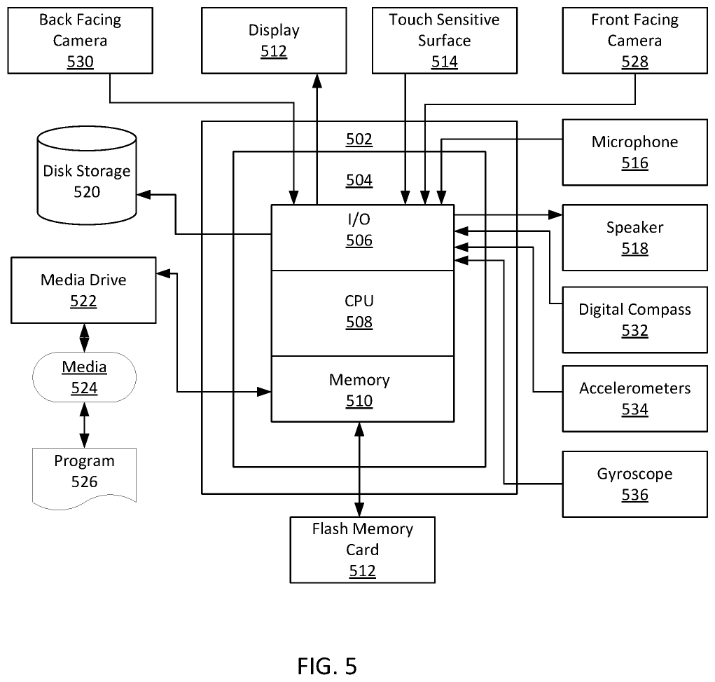

FIGS. 1A-1B depicts smart device 100 that optionally implements some embodiments of the present invention. In some examples, smart device 100 is a smart phone or tablet computing device but the present technology can also be implemented on other types of specialty electronic devices, such as wearable devices, cameras, or a laptop computer. In some embodiments smart device 100 is similar to and includes components of computing system 500 described below in FIG. 5. Smart device 100 includes touch sensitive display 102 and back facing camera 124. Smart device 100 also includes front facing camera 120 and speaker 122. Smart device 100 optionally also includes other sensors, such as microphones, movement/orientation sensors (e.g., one or more accelerometers, gyroscopes, digital compasses, etc.), depth sensors (which are optionally part of camera 120 and/or camera 124), etc.

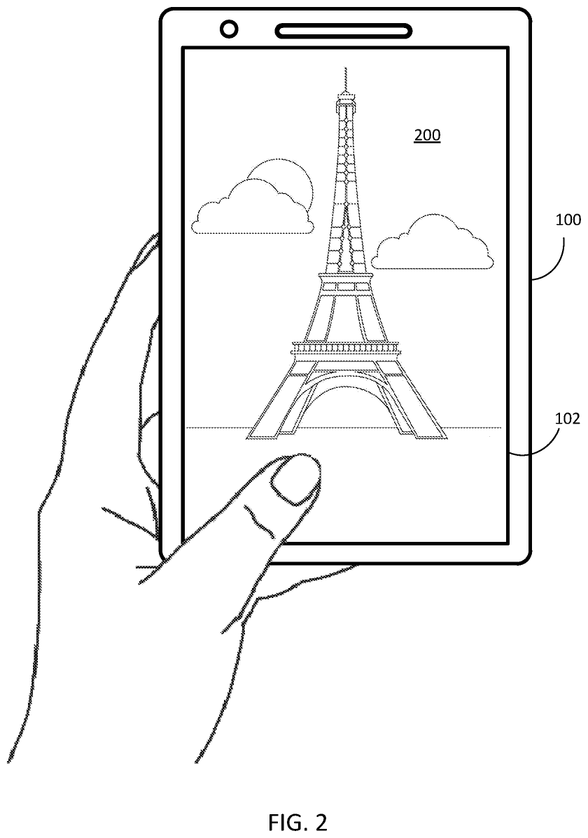

The photographer selects an available background from an online or off-line database. In the example shown in FIG. 2, VR view 200 of Eiffel Tower is selected. VR view 200 is optionally a view of a VR environment that is based on real world imagery, computer generated imagery, or a combination of both.

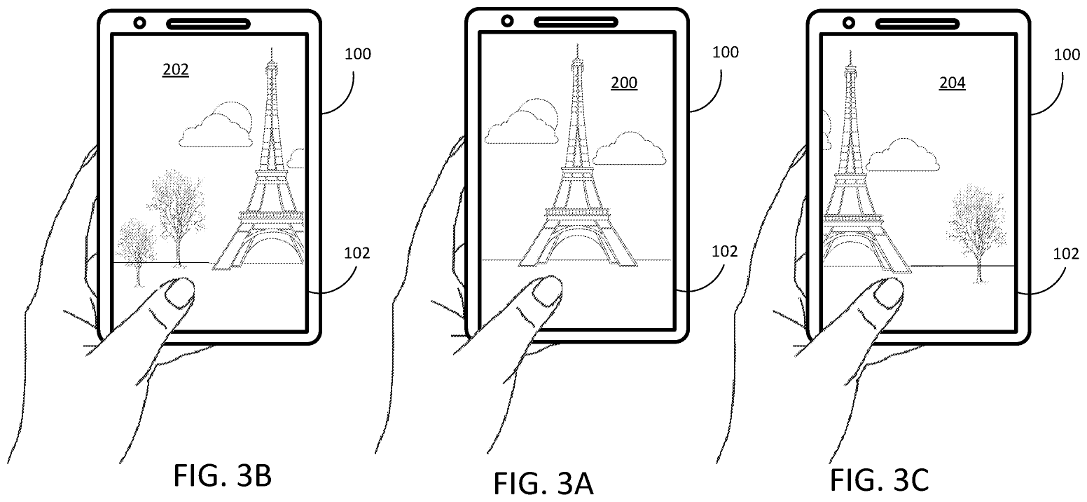

Once the background is selected, the photographer is able to zoom in to a closer look of the background, and move the view-finder to view the VR background in a 360-degree manner, as depicted in FIGS. 3A-3C. For example, the movement of the VR environment to produce VR views 200, 202, or 204 as background in FIGS. 3A-3C may occur as the result of manipulation of device 100, which may occur via input detected with orientation sensors, with the touch display, or other user input mechanisms. For example, VR view 200 in FIG. 3A is transitioned to VR view 202 in FIG. 3B in response to an input that is interpreted as a pan movement to the left. In some cases, the input is a tilting or rotations of device 100 or a gesture (e.g., a swipe or draft gesture) received on touch sensitive display 102. As another example, VR view 200 in FIG. 3A is transitioned to VR view 204 in FIG. 3C in response to an input that is interpreted as a pan movement to the right. In some cases, the input is a tilting or rotations of device 100 or a gesture (e.g., a swipe or draft gesture) received on touch sensitive display 102. Other inputs (e.g., movement of device 100 or gestures on touch sensitive display 102) can be used to perform other manipulations (e.g., zooming, tilting, rotation, lighting changes, etc.) of the VR environment to produce other VR views.

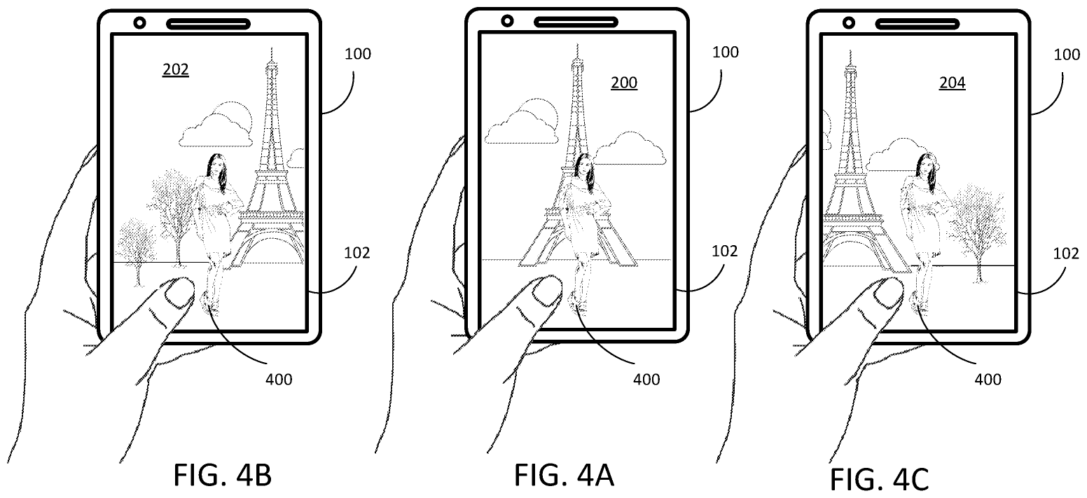

According to the selected background view, the photographer can then move the view-finder to an angle best fit to the subject (e.g., a model or an object). This can be thought of as the user positioning a virtual camera representing device 100′s view in the VR environment. From the photographer's point of view, the effect is exactly like moving the camera against a real background. FIGS. 4A-4C depict an example. In the example, model 400 is shown in front of the VR view backgrounds in FIGS. 3A-3C. In response to the user input to modify the positioning of the background (as described with respect to FIGS. 3A-3C), the background is updated without affecting model 400 so that model 400 is positioned in the desired location. The camera device will then process the picture by overlaying the image of the model on top of the VR view (this can be seen as an opposite of the traditional augmented reality technology that overlays virtual objects on real images). Optionally, the device can process the image to automatically add any number of photographic effects, such as shadowing or lighting, onto the background view to make the output picture even more realistic.

The photographer can also adjust the size of the background to ensure that it appears in the correct proportion against the subject (e.g., make the Eiffel Tower larger or smaller with respect to the model in FIGS. 4A-4C). In some examples, a tilting input of device 100 may change the zoom level of the VR view used as the background. In some other examples, a gesture, such as a pinch or expand gesture, may be used to change the zoom level of the VR view.

Input received from one or more sensors different form the sensor that modifies the VR view can be used to modify the object (e.g., model 400). For example, if input received using one or more orientations sensors modifies the VR view being used as the background, then input received via touch sensitive display 102 may modify the image of the object being photographed. In this manner, both the object of the photograph and the selected background can be manipulated without having to switch focus between the object and the background. This provides for a more efficient and intuitive user interface.

Optionally, the subject can actually be positioned on a different height relative to photographer when necessary. For example, model 400 in FIGS. 4A-4C could be moved to be positioned below or above the Eiffel Tower or in a different perspective with respect to the photographer. This operation can be performed via input received at device 100.

Turning now to FIG. 5, components of an exemplary computing system 500, configured to perform any of the above-described processes and/or operations are depicted. For example, computing system 500 may be used to implement camera device 100 described above that implements any combination of the above embodiments. Computing system 500 may include, for example, a processor, memory, storage, and input/output peripherals (e.g., display, keyboard, stylus, drawing device, disk drive, Internet connection, camera/scanner, microphone, speaker, etc.). However, computing system 500 may include circuitry or other specialized hardware for carrying out some or all aspects of the processes.

In computing system 500, the main system 502 may include a motherboard 504 with a bus that connects an input/output (I/O) section 506, one or more microprocessors 508, and a memory section 510, which may have a flash memory card 512 related to it. Memory section 510 may contain computer-executable instructions and/or data for carrying out the processes above. The I/O section 506 may be connected to display 524 (e.g., to display a view), a camera/scanner 526, a microphone 528 (e.g., to obtain an audio recording), a speaker 530 (e.g., to play back the audio recording), a disk storage unit 516, and a media drive unit 518. The media drive unit 518 can read/write a non-transitory computer-readable storage medium 520, which can contain programs 522 and/or data used to implement process 200 and/or process 500.

Additionally, a non-transitory computer-readable storage medium can be used to store (e.g., tangibly embody) one or more computer programs for performing any one of the above-described processes by means of a computer. The computer program may be written, for example, in a general-purpose programming language (e.g., Pascal, C, C++, Java, or the like) or some specialized application-specific language.

Computing system 500 may include various sensors, such as front facing camera 530, back facing camera 532, orientation sensors (such as, compass 534, accelerometer 536, gyroscope 538), and/or touch-sensitive surface 540. Other sensors may also be included.

While the various components of computing system 500 are depicted as separate in FIG. 5, various components may be combined together. For example, display 524 and touch sensitive surface 540 may be combined together into a touch-sensitive display.

Various exemplary embodiments are described herein. Reference is made to these examples in a non-limiting sense. They are provided to illustrate more broadly applicable aspects of the disclosed technology. Various changes may be made and equivalents may be substituted without departing from the true spirit and scope of the various embodiments. In addition, many modifications may be made to adapt a particular situation, material, composition of matter, process, process act(s) or step(s) to the objective(s), spirit or scope of the various embodiments. Further, as will be appreciated by those with skill in the art, each of the individual variations described and illustrated herein has discrete components and features which may be readily separated from or combined with the features of any of the other several embodiments without departing from the scope or spirit of the various embodiments.

Exemplary methods, non-transitory computer-readable storage media, systems, and electronic devices are set out in the following items:

1. A method, comprising:

at an electronic device having a display, memory, and an image sensor:
capturing image data from the image sensor;
receiving a selection of a background image from a user of the electronic

device, wherein the background image is not based on image data from the image sensor;
displaying a view on the display or view-finder, wherein the view is based on the captured image data and the selected background image;
receiving first user input at the electronic device;
updating the displayed view by modifying the background image in accordance with the first user input while maintaining the display of the captured image data; and
storing the view as image data in the memory.

2. The method of item 1, wherein the background image is a virtual reality image.

3. The method of item 1, wherein the background image is a virtual reality video.

4. The method of any one of items 1-3, wherein the electronic device further includes an orientation sensor that receives the user input

5. The method of any one of items 1-4, wherein modifying the background image includes resizing the background image.

6. The method of item 2, wherein modifying the background image includes rotating the virtual reality image.

7. The method of item 3, wherein modifying the background image includes rotating the virtual reality video.

8. The method of any one of items 1 or 4-5, wherein modifying the background image includes translating the background image in accordance with the user input.

9. The method of any one of items 1-6 further comprising:

performing image processing on the background image without performing image processing on the foreground image.

10. The method of any one of items 1-9, wherein the first user input is received via a first sensor of the electronic device, the method further comprising:
receiving second user input at the electronic device; and
updating the displayed view by modifying the displayed captured image in accordance with the second user input while maintaining the display of the background image.

11. A non-transitory computer-readable storage medium encoded with a computer program executable by an electronic device having a display, memory, and an image sensor, the computer program comprising instructions for performing the steps of the method of any of items 1-10.

12. An electronic device comprising:
a display;
an image sensor;
a processor; and
memory encoded with a computer program executable by the processor, the computer program having instructions for performing the steps of the method of any of items 1-10.

1. A method, comprising:
at an electronic device having a display, memory, and an image sensor:
capturing image data from the image sensor;
receiving a selection of a background image from a user of the electronic device, wherein the background image is not based on image data from the image sensor;
displaying a view on the display or view-finder, wherein the view is based on the captured image data and the selected background image;
receiving first user input at the electronic device;
updating the displayed view by modifying the background image in accordance with the first user input while maintaining the display of the captured image data; and
storing the view as image data in the memory.

2. The method of claim 1, wherein the background image is a virtual reality image.

3. The method of claim 1, wherein the background image is a virtual reality video.

4. The method of claim 1, wherein the electronic device further includes an orientation sensor that receives the user input.

5. The method of claim 1, wherein modifying the background image includes resizing the background image.

6. The method of claim 2, wherein modifying the background image includes rotating the virtual reality image.

7. The method of claim 3, wherein modifying the background image includes rotating the virtual reality video.

8. The method of claim 1, wherein modifying the background image includes translating the background image in accordance with the user input.

9. The method of claim 1 further comprising:
performing image processing on the background image without performing image processing on the foreground image.

10. The method of claim 1, wherein the first user input is received via a first sensor of the electronic device, the method further comprising:
receiving second user input at the electronic device; and
updating the displayed view by modifying the displayed captured image in accordance with the second user input while maintaining the display of the background image.

11. A non-transitory computer-readable storage medium encoded with a computer program executable by an electronic device having a display, memory, and an image sensor, the computer program comprising instructions for:
capturing image data from the image sensor;
receiving a selection of a background image from a user of the electronic device, wherein the background image is not based on image data from the image sensor; displaying a view on the display or view-finder, wherein the view is based on the captured image data and the selected background image;
receiving first user input at the electronic device;
updating the displayed view by modifying the background image in accordance with the first user input while maintaining the display of the captured image data; and
storing the view as image data in the memory.

12. An electronic device comprising:
a display;
an image sensor;
a processor; and
memory encoded with a computer program executable by the processor, the computer program having instructions for:
capturing image data from the image sensor;
receiving a selection of a background image from a user of the electronic device, wherein the background image is not based on image data from the image sensor;
displaying a view on the display or view-finder, wherein the view is based on the captured image data and the selected background image;
receiving first user input at the electronic device;
updating the displayed view by modifying the background image in accordance with the first user input while maintaining the display of the captured image data; and
storing the view as image data in the memory.
